(19) United States
(12) Patent Application Publication
(10) Pub. No.: US 2025/0344899 A1
(43) Pub. Date: Nov. 13, 2025

(54) FLUID FLOW

(71) Applicant: Société des Produits Nestlé S.A., Vevey (CH)

(72) Inventors: Matthias FELBER, Speicher (CH); Sara HANZI, Winterthur (CH); Urban NUSSLI, St. Gallen (CH); Vincent ROGNON, Orbe (CH)

(21) Appl. No.: 18/867,467

(22) PCT Filed: May 30, 2023
(86) PCT No.: PCT/EP2023/064370

§ 371 Date: Nov. 20, 2024

(30) Foreign Application Priority Data
May 31, 2022 (EP) 22176353.5

(51) Int. Cl. A47J 31/46; A47J 31/52; G01F 9/00

(52) U.S. Cl. CPC A47J 31/468; A47J 31/52; G01F 9/008

(57) ABSTRACT

A method for estimating a volume of liquid output from an electric pump during an operation period of the electric pump, the method comprising: determining a current delay of the pump, wherein the current delay is a period between a first time corresponding to a first current drawn by the pump, and a second time corresponding to a second current drawn by the pump; and generating, based on the current delay, an estimate of the volume of liquid output from the electric pump during the operation period.

### FIELD AND BACKGROUND

The present techniques relate to flow estimation in the field of electric pumps. More particularly, but not exclusively, the present techniques relate to estimating a volume of liquid or flow output from an electric pump without using a flowmeter.

Beverage preparation apparatuses, or liquid dispensing machines, often include one or more electric pumps for causing the passing of liquid through a liquid path within the apparatus or machine. In such situations, the flow (often expressed as volume per unit time) of liquid output from the electric pump is measured and summed to determine the total volume of liquid output from the beverage preparation apparatus, for example to indicate when to stop liquid output from the apparatus.

Conventionally, a flowmeter is used to measure the flow of liquid output from an electric pump. However, such flowmeters can increase the manufacturing complexity of the overall system, increase manufacturing cost, introduce an additional point of failure, and introduce irregularities into the liquid path. It may therefore be appropriate to estimate the flow (used herein interchangeably with the conceptual description of volume per unit time) of liquid output from an electric pump without using a flowmeter.

Known approaches are presented in EP2548483 and US2013094840, which attempt to estimate the water flowing through a heater based on a measured temperature of the water and the physical formula relating to the energy required to heat a specific amount of water. Other known approaches are presented in WO12062628 and EP3097827.

However, as recognised by the inventors of the present approaches, existing methods for estimating flow of a liquid without a dedicated flowmeter can lack accuracy, and in some cases require the introduction of other complex hardware devices or rely upon estimating additional values of parameters, thereby introducing further uncertainty into the estimation of the flow.

### SUMMARY

Particular aspects and embodiments are set out in the appended claims.

Viewed from a first aspect, there is provided a method for estimating a volume of liquid output from an electric pump during an operation period of the electric pump, the method comprising: determining a current delay of the pump, wherein the current delay is a period between a first time corresponding to a first current drawn by the pump, and a second time corresponding to a second current drawn by the pump; and generating, based on the current delay, an estimate of the volume of liquid output from the electric pump during the operation period. Thereby, there is provided an approach for efficiently and accurately estimating flow output from an electric pump, by using parameters that relate directly to the operation of the electric pump. Accordingly, a flowmeter may be omitted.

Viewed from a further aspect, there is provided a liquid dispensing machine comprising an electric pump and processing circuitry configured to perform the methods described herein. Thereby, there is provided a liquid dispensing machine configured to efficiently and accurately estimate a flow output from an electric pump by using parameters that relate directly to the operation of the electric pump. Accordingly, a flowmeter may be omitted from the liquid dispensing machine.

Viewed from a further aspect, there is provided a computer-readable medium comprising instructions which, when executed by a programmable liquid dispensing machine, cause the programmable liquid dispensing machine to carry out the methods described herein. Thereby, there is provided a computer-readable medium comprising instructions which, when executed by a programmable liquid dispensing machine, cause the programmable liquid dispensing machine to efficiently and accurately estimate a flow output from an electric pump by using parameters that relate directly to the operation of the electric pump.

Viewed from a further aspect, there is provided a method for training a regression model to estimate a volume of liquid output from an electric pump during an operation period of the electric pump, the model comprising: obtaining training data comprising values of current delays of a test apparatus and volumes of liquid output by the test apparatus during operation of the test apparatus, wherein: the test apparatus corresponds to the electric pump; and the current delays are periods between a first time corresponding to a first current drawn by the test apparatus, and a second time corresponding to a second current drawn by the test apparatus; and performing regression analysis on the training data to provide one or more parameters usable to estimate the volume of liquid output from the electric pump from a measurement of a current delay of the electric pump. Thereby, there is provided an approach for training a regression model to efficiently and accurately estimate flow output from an electric pump, by using parameters that relate directly to the operation of the electric pump.

Viewed from a further aspect, there is provided a beverage preparation apparatus comprising: a fluid input connected to receive fluid for beverage preparation; an electric pump connected to the fluid input, and having a control input; a current sensor connected to an electrical power connection of the electric pump; a beverage preparation output connected to receive fluid dispensed by the electric pump; and a controller connected to the current sensor and to the control input, wherein the controller is configured to calculate a fluid volume dispensed by the electric pump based on a current draw delay measured by the current sensor, and to send a control signal to the control input to deactivate the electric pump responsive to the fluid volume reaching a threshold volume. Thereby, there is provided a beverage preparation apparatus configured to efficiently and accurately estimate flow output from an electric pump, by using parameters that relate directly to the operation of the electric pump. Accordingly, a flowmeter may be omitted from the beverage preparation apparatus.

Other aspects will also become apparent upon review of the present disclosure, in particular upon review of the Brief Description of the Drawings, Detailed Description, Drawings and Claims.

### BRIEF DESCRIPTION OF THE DRAWINGS

Examples of the disclosure will now be described, by way of example only, with reference to the accompanying drawings in which:

FIG. 1: schematically illustrates a beverage preparation apparatus configured to operate according to teachings of the present disclosure.

FIG. 2: illustrates a relationship between flow and the current delay according to the teachings of the present disclosure.

FIG. 3: schematically illustrates a method for estimating a volume of liquid output from an electric pump during an operation period of the electric pump according to teachings of the present disclosure.

FIG. 4: illustrates a relationship between current drawn by an electric pump and time according to teachings of the present disclosure.

FIG. 5: illustrates a relationship between flow and current delay for three supply voltages according to techniques of the present disclosure.

FIG. 6: comprises FIGS. 6a and 6b, which illustrate a relationship between time and pump power, and time and cumulative volume according to techniques of the present disclosure.

FIG. 7: illustrates a relationship between time and cumulative volume for different temperature liquids according to techniques of the present disclosure.

FIG. 8: schematically illustrates a method for calculating a cumulative volume of liquid output from an electric pump according to techniques of the present disclosure.

FIG. 9: schematically illustrates a method for estimating a volume of liquid output from an electric pump when a supply voltage varies according to techniques of the present disclosure.

FIG. 10: schematically illustrates a method for training a regression model to estimate a volume of liquid output from an electric pump during an operation period of the electric pump.

FIG. 11: illustrates an estimation performance of the techniques of this disclosure for estimating a volume of liquid output from an electric pump during an operation period of the electric pump.

While the disclosure is susceptible to various modifications and alternative forms, specific example approaches are shown by way of example in the drawings and are herein described in detail. It should be understood however that the drawings and detailed description attached hereto are not intended to limit the disclosure to the particular form disclosed but rather the disclosure is to cover all modifications, equivalents and alternatives falling within the spirit and scope of the claimed invention.

It will be recognised that the features of the above-described examples of the disclosure can conveniently and interchangeably be used in any suitable combination.

### DETAILED DESCRIPTION

The present approaches as described below relate to estimation of a flow output from an electric pump. Although these approached are described in the context of beverage preparation apparatus, it will be appreciated that the techniques for flow estimation can be applied to a wide variety of arrangements in which an electric pump is used to output a flow of liquid. Such estimation may be used for control of a liquid amount output by the pump, for example to permit control of an activation window of the pump to output a known volume of liquid. Such estimation may also or alternatively be used to keep track of a total liquid output by the pump, for example over a particular time period and/or over an operational lifetime of the pump.

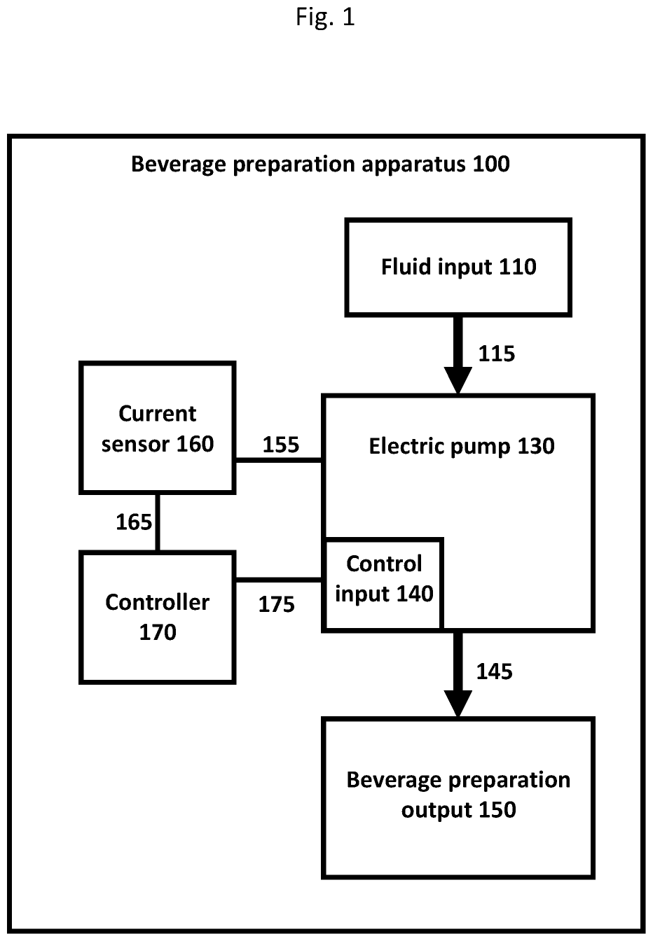

FIG. 1 schematically illustrates a beverage preparation apparatus. The beverage preparation apparatus 100, or liquid dispensing machine, may in some examples be a coffee machine or a capsule-based coffee machine. As noted above, the techniques described herein may be applied to any apparatus or machine comprising an electric pump configured to output liquid or fluid. Indeed, such an electric pump, in some examples, may be an oscillating pump or a positive-displacement pump, for example an oscillating piston pump or an oscillating plunger pump.

In the current example, the beverage preparation apparatus 100 comprises a fluid input 110 connected to receive fluid for beverage preparation. Beverage preparation apparatus 100 further comprises an electric pump 130 connected to the fluid input 110 and having a control input 140. Fluid input 110 and electric pump 130 are connected by fluid path 115 for allowing the passage of fluid from the fluid input 110 to the electric pump 130. Beverage preparation apparatus 100 further comprises a current sensor 160 connected to an electrical power connection of the electric pump 130, indicated by the connection 155, and configured to measure current drawn by the electrical pump 130.

The beverage preparation apparatus 100 further comprises a beverage preparation output 150 connected to receive fluid dispensed by the electric pump 130. The electric pump 130 and the beverage preparation output 150 are connected by fluid path 145 for allowing the passage of fluid from the electric pump 130 to the beverage preparation output 150.

The current sensor 160 is further connected to a controller 170, indicated by connection 165, such that the measurements of current drawn by the electric pump 130 are provided to the controller 170. The controller 170 is also connected to the control input 140 of the electric pump 130, indicated by connection 175. The controller 170 is configured to calculate a fluid volume dispensed by the electric pump 130 based on a current draw delay measured by the current sensor 160, and to send a control signal to the control input 140 of the electric pump 130 to deactivate the electric pump 130 responsive to the fluid volume reaching a threshold volume.

It will be appreciated that the beverage preparation apparatus 100 may comprise additional components that are not shown in FIG. 1. For example, additional components may be present in the fluid path between the fluid input 110 and the electric pump 130, and in the fluid path between the electric pump 130 and the beverage preparation output 150. For example, some form of beverage preparation chamber and/or a heating component may be provided between the electric pump 130 and the beverage preparation output 150, and/or some form of fluid input filter may be present between the fluid input 110 and the electric pump 130.

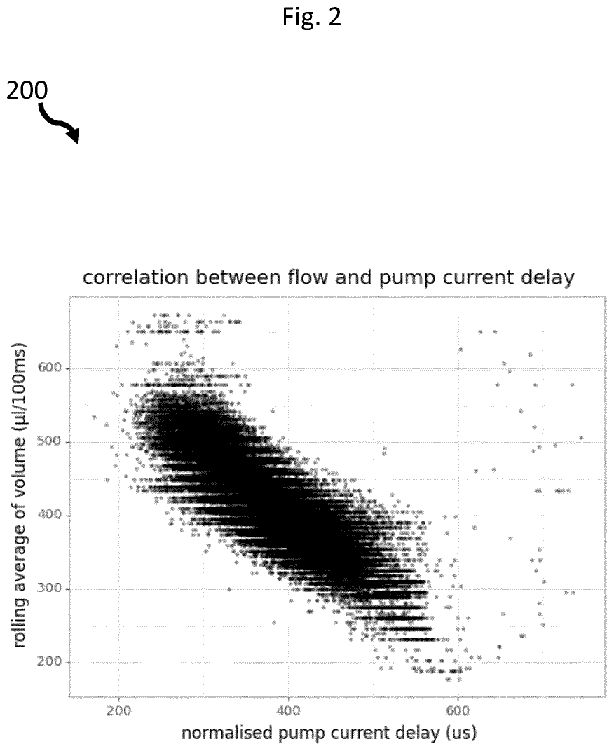

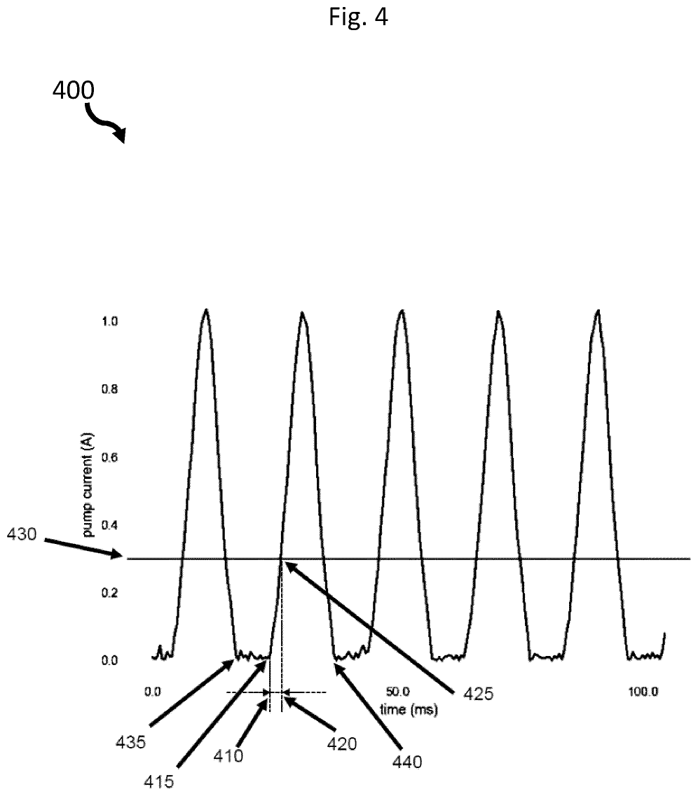

FIG. 2 shows a relationship between liquid flow, or volume of liquid per unit of time, of liquid output from an electric pump during operation of the electric pump and a current delay parameter of the electric pump. Specifically, the inventors of the present approaches have identified that the volume of liquid output from an electric pump correlates to a current delay of the electric pump. This current delay of an electric pump as used herein is a period of time between a first time corresponding to a first current drawn by the electric pump, and a second time corresponding to a second current drawn by the pump. The first current and second current are discussed in greater detail below, and in particular with reference to FIG. 4.

As shown in FIG. 2, generally, the greater the current delay of the electric pump, the lesser the volume of liquid output from an electric pump per unit time, in other words the lesser the flow of liquid output from the pump. Conversely, a lesser current delay generally corresponds to a greater flow of liquid output from the pump. The inventors of the present invention, having identified this correlation, recognised that this relationship allows for the generation of an estimate of the volume of liquid output from an electric pump during an operation period of the electric pump, based on a determination of the current delay of the electric pump.

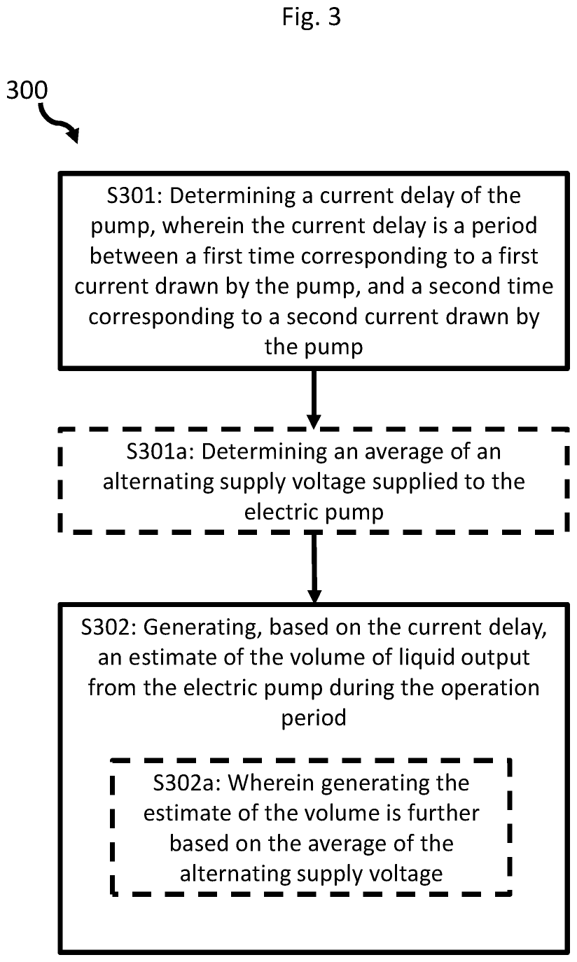

FIG. 3 schematically illustrates a method 300 for estimating a volume of liquid output from an electric pump during an operation period of the electric pump according to the teachings of the present disclosure. The method 300 includes the following steps.

At step S301, a current delay of the electric pump is determined. The current delay, as described above, is a period between a first time corresponding to a first current drawn by the pump, and a second time corresponding to a second current drawn by the pump.

At step S302, an estimate of the volume of liquid output from the electric pump during the operation period is generated based on the current delay.

Thus, the present approach enables the estimation of the volume of liquid output from an electric pump during an operation period of the pump without the use of a dedicated flowmeter. In so doing, the manufacturing complexity of the system may be decreased, the manufacturing cost of the system may be decreased, a point of failure of the system may be removed (the flowmeter), and irregularities in the liquid path may be reduced. Any one or more of these outcomes may be provided in any particular implementation, thereby providing a more efficient manufacturing process and/or a more reliable operation.

Further, as the estimation is generated based on a current delay of the electric pump, so consequently a requirement to introduce other complex hardware devices is avoided, and reliance upon parameters which have themselves been estimated is also avoided. Accordingly, the present approaches can avoid introducing further uncertainty into the estimation of the flow when a flowmeter is omitted. Thus, the present approaches are able to provide a more accurate estimation of flow in the absence of a flowmeter. Further, as the estimation of the flow is based on a current delay of the electric pump, i.e. based on a single hardware device, the efficiency of the calculation is increased.

The above discussion and FIG. 3 refers to a current delay of the pump, a first time corresponding to a first current drawn by the pump, and a second time corresponding to a second current drawn by the pump. The determination of the current delay and the first and second times and currents will now be described in greater detail with reference to FIG. 4.

FIG. 4 shows a relationship between a pump current, i.e. current drawn by the electric pump, and time. More particularly, FIG. 4 shows five pump cycles across a time period of approximately 100 ms. Each pump cycle is characterised by an increase from a current drawn by the pump of approximately zero which, after a short period of noise-like behaviour, rapidly increases in a substantially linear manner (i.e. with a substantially constant rate of change), before increasing less rapidly and reaching a peak current, and again returning to the noise-like behaviour and ultimately to a time where no current is drawn. In the example depicted in FIG. 4, the peak current is approximately 1 A, and current at the transition from having a substantially linear increase to having a less-linear increase is approximately 0.3 A. It will however be appreciated that the present disclosure is not limited to such specific values, and indeed the specific values for any given implementation will vary as a function of the specific pump

Time 410 on FIG. 4 may indicate the first time, and time 420 may indicate the second time. As shown, the first time 410 corresponds to a first current 415 drawn by the pump and the second time 420 corresponds to a second current 425 drawn by the pump. The first current may substantially correspond to a zero-crossing of an alternating supply voltage supplied to the pump. For example, the first current may be the current drawn by the pump when the alternating supply voltage supplied to the pump crosses the point of zero voltage, or when a sign of the voltage of the alternating voltage changes from negative to positive, although in other examples this may be vice versa. Alternatively, the first current may be a predefined current, in which case first time would be the time that the current drawn by the pump reaches this predefined current. Further, the first current may be a current drawn by the pump determined by analysing the current drawn by the pump over a rolling time window where it is determined that the current has increased past the noise-like behaviour. Alternatively, the first current may be a current determined by empirical or experimental analysis of the current characteristics of the electric pump or a pump corresponding to the electric pump.

The second time 420 may correspond to a time proximal to the end of or within a time period over which a current drawn by the pump has substantially constant rate of change. In other words, the second time 420 may be a time at the end of, just after, or within the period of time when the current drawn by the pump is increasing at a constant rate. With reference to FIG. 4, the second time 420 corresponds to the end of the period over which a current drawn by the pump has substantially constant rate of change, this point being indicated by 425. As noted above, in the example shown in FIG. 4, this second time 420 and point 425 corresponds to the current drawn by the pump having a value of approximately 0.3 A, as indicated by point 430 on the graph. The second time 420 may be a time determined by performing empirical or numerical analysis on the current drawn over time by the electric pump or a pump corresponding to the electric pump. As for the first time, the second time 420 may be determined based on analysis of the current drawn by the pump over a rolling time window.

Further, in some examples, the second time 420 may be a time determined based on the current drawn by the pump at that time. Specifically, it may be appropriate to ensure that the second time 420 does not correspond to a current drawn by the pump that is beyond a predetermined position of the current curve. This may be appropriate so as to allow for variations in a pressure of the liquid, for example when the pressure is low. This may be relevant in the context of beverage preparation apparatuses or indeed any machine that is fed liquid by a connection pipe that provide a low or inconsistent liquid pressure, rather than from an inbuilt reservoir.

In some examples, the second time 420 may be determined based on the second time 420 being within a predetermined time duration from the first time 410. As an example, this predetermined time duration may be X seconds, and the first time may correspond to Y seconds. Following this example, the second time 420 may be determined as a time within X+Y seconds, or equal to X+Y seconds.

It will be appreciated that the first time 410 and the second time 420 may be determined by measuring the current drawn by the pump. For example, an ammeter functionality may be used to measure current throughout operation of the pump. In so doing, the current delay may be determined by measurements of the current drawn by the pump alone. This provides an efficient and fast generation of the estimate of flow.

Alternatively, in some examples, the first time 410 may be determined based on measurements of an alternating supply voltage supplied to the pump during the operation period of the pump. The second time 420 may be determined based on measurements of a current drawn by the pump during the operation period. The calculated difference between the first time and the second time thus provides the current delay of the pump. Following this example, and with reference to FIG. 4, the current delay may be calculated as a difference between the first time 410 and the second time 420, for example by subtracting the first time 410 from the second time 420.

In this way, the first time 410 may be determined by measuring an alternating supply voltage of the pump, for example by determining the time corresponding to a zero-crossing of the supply voltage as the first time. In some cases, and as shown in FIG. 4, the current drawn by the pump can be erratic, and noisy, near zero current and as such determining a first current using a predefined current, and then determining the first time as the time at which the pump draws this predefined current, can be prone to error. Instead, and as discussed, a measurement of the alternating supply voltage, and the zero-crossing of this alternating voltage supply may be used. In doing so, the accuracy of the determination of the first time 410 may be increased, leading to a more accurate estimation of flow.

As shown in FIG. 4, the current delay may be determined by subtracting the first time 410 from the second time 420. Thus far, the zero-crossing of the alternating supply voltage has referred to the increasing zero-crossing, i.e. the zero-crossing where the voltage is turning from negative to positive. In other examples, the falling zero crossing of the alternating supply voltage may be used, i.e. corresponding to the current drawn by the pump in the latter half of a pump cycle. Such an approach may be able to disregard any noise-like behaviour around the zero current point as the first time at which the current reaches zero (or substantially zero) may be used as the zero-crossing point. This is described with reference again to FIG. 4. The times labelled 435 and 440 may correspond to falling zero-crossings of the alternating supply voltage supplied to the pump. In this example, the current delay is determined as follows: current delay=((440−435)/2)−(440−420). In some hardware configurations, measuring the current delay in this manner can be more accurate.

In some examples, in step S301 of method 300, the current delay determination, may be repeated before the method 300 proceeds to the volume estimate generation in step S302. Thus, in this example, the volume estimate may be generated based on an average current delay of the pump. In some examples, a current delay is determined for each pump cycle, which may correspond to determining a current delay approximately every 20 ms, and then after five current delay determinations, an estimate of the volume may be generated based on an average of the five determined current delays. Accordingly, in some examples, the estimate of the volume may be generated every 100 ms, whereas the current delay may be determined every 20 ms. It will be appreciated that the number of current delays used for the average may vary.

With reference again to FIG. 3, method 300 may, in some examples, also include steps S301a and S302a. At step S301a, an average of an alternating supply voltage supplied to the electric pump is determined. The average of the alternating supply voltage may be a supply voltage provided from a mains electricity grid or power grid. Thus, in some examples, this average refers to a root mean squared average of the alternating supply voltage over a period of time. Examples of average alternating supply voltages that may be supplied to the electric pump include 110V, 120V, 220V, 230V, and 240V, among others. It will be appreciated that the average alternating supply voltage supplied to the electric pump may refer to the nominal supply voltage, i.e. the voltage at the point of interconnection between the electrical utility and apparatus, or the voltage actually utilised by the electric pump. This alternating supply voltage may be determined in a number of ways, for example from direct measurement, from measuring the supply voltage from the grid, or based on a phase cut applied to the supply voltage from the grid.

While step S302a has been shown in FIG. 3 as a separately labelled step, it will be appreciated that step S302a optionally modifies step S302 rather than representing a further separate step. At step S302a, an estimate of the volume of liquid output from the electric pump during the operation period is generated based on the current delay and the average of the alternating supply voltage.

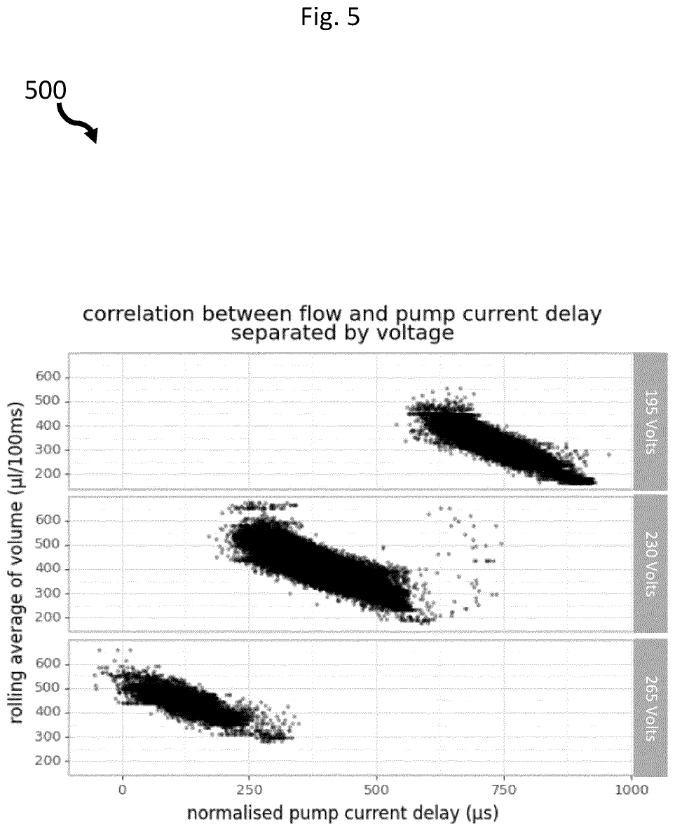

Thus, in this example, a current delay of the pump and an average of an alternating supply voltage supplied to the pump are determined, and the estimate of the flow is generated based on both the current delay and the average of the alternating supply voltage. The inventors of the present approaches have identified that the flow and current delay correlation, as shown in FIG. 2, is dependent on the supply voltage, for example whether 230V, 195V or 265V was supplied to the pump from the grid. This can be seen in FIG. 5, which shows a relationship between liquid flow, or volume of liquid per unit of time, and current delay for different levels of average alternating supply voltage supplied to the pump. Generally, a higher supply voltage, in this case 265V, results in a lower average determined current flow.

Accordingly, in some example methods that include steps S301a and S302a, the flow estimate generation is further based on the supply voltage. Introducing this additional parameter into the estimation approach may, in some implementations, result in further increased accuracy of the flow estimation.

In some examples, generating the estimate of the volume of liquid output from the pump is further based on a technique selected from a plurality of techniques, the selection based on an indication of whether a power of the pump during the operation period of the pump is above a predefined power threshold.

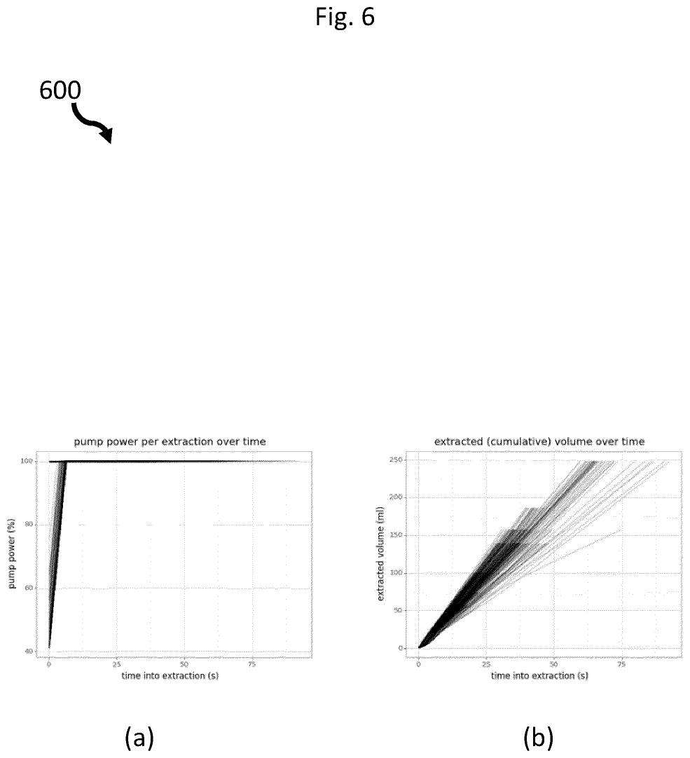

FIG. 6a shows the power of an electric pump during operation over time. As shown, the power of the pump does not begin at 100%, instead a ramp-up period is present of varying durations. In some examples, such as those relating to a beverage preparation apparatus, the power of the pump is intentionally ramped-up over a period of time, for example approximately 7 seconds as shown in FIG. 6a, to full power. This may be due to an indication that a heating operation is to be applied to the liquid passing through the pump, for example to provide a hot beverage. In such cases, the thermoregulation may be such that for hot beverages the pump cannot be started at full power. This may occur for example where heating of the liquid after output of the liquid from the pump is performed by a heater which requires a certain time to reach full operating temperature (for example due to thermal losses in a pre-heat phase) and/or a heater with low thermal mass. With such a pump-ramp-up, like that shown in FIG. 6a, the cumulative volume of liquid output from the pump behaves differently at different times.

This behaviour is shown in FIG. 6b. For a time period corresponding to the time period of the power ramp-up of the pump, approximately 7 seconds in this example, the cumulative volume increases at a varying rate and a rate different from that when the pump is operating at 100%. Accordingly, a more accurate estimate of the flow and volume of liquid output from the pump over time can be realised by taking into account the power of the pump when selecting the technique to use to generate the estimate.

For example, one technique of the plurality of techniques may be optimised for generating the estimate when the pump power is below a predetermined amount of the pump's nominal or maximum operating power, for example 100% of full power or 70% of full power. A different technique of the plurality of techniques may be optimised for generating the estimate when the pump power is operating about the predetermined power level, for example substantially at 100%, or above the predetermined threshold of 70%. Thus, selecting which of a plurality of techniques to use in the estimate generation based on the power of the pump, and particularly based on whether or not the power is above a predefined power threshold may result in a more accurate flow estimate for certain implementations.

As will be appreciated, the indication of whether a power of the pump is above or below a predefined threshold could be measured or calculated directly or indirectly. Alternatively, an indication may be received.

In some examples, generating the estimate of the volume of liquid output from the pump is further based on a technique selected from a plurality of techniques, the selection based on an indication of whether a temperature of the liquid is greater than a predefined temperature threshold or whether a heating operation is to be applied to the liquid.

As discussed, if a heating operation is to be applied to the liquid being pumped, the pump may need to undergo a power ramp-up. Accordingly, rather than relying on an indication of whether the pump power is above a threshold, or indeed a measurement or calculation of the pump power, the selection may be based on an indication that a heating operation is to be applied to the liquid. In some cases, this could be caused by a user of a beverage preparation apparatus selecting a hot beverage for preparation. In other cases, the selection may be based on whether a temperature of the liquid is greater than a predefined temperature, thus identifying that a heating operation has been applied. In some examples, the temperature may be sensed by a temperature sensor. In other examples, processing circuitry is configured to receive an indication that a heating operation is to be applied to the liquid, and select the technique based on that.

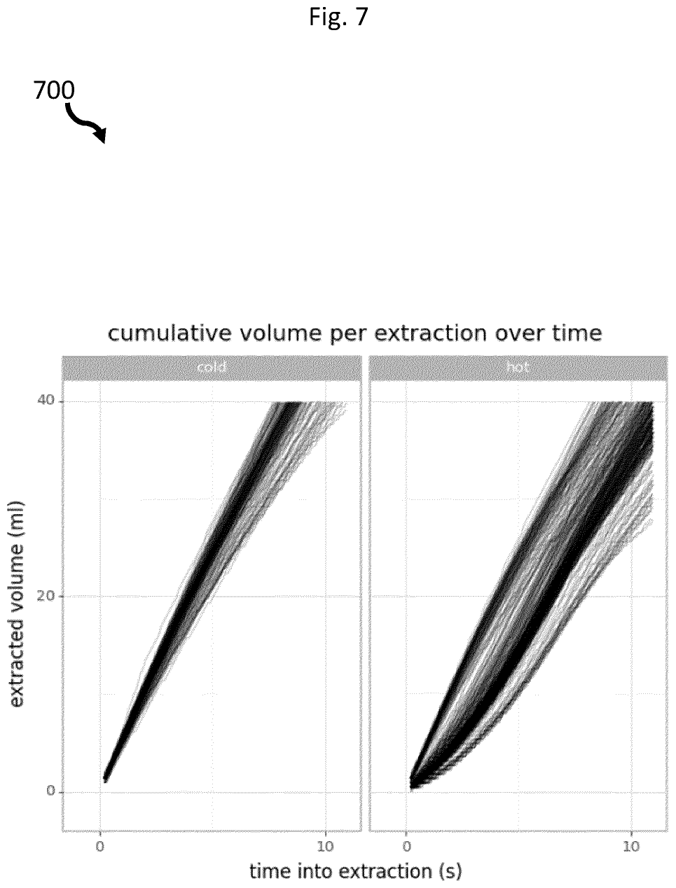

FIG. 7 shows a relationship of cumulative volume and time for both hot and cold beverages, in the context of a beverage preparation apparatus. As shown, the rate at which the cumulative volume increases, i.e. the extraction of the liquid, is dependent on whether a hot beverage or cold beverage is being extracted. In some examples, this may be due to a flow restriction caused by a heater path through which liquid output from the pump is passed in order to heat the pumped liquid and/or due to different physical properties of the liquid at different temperatures. Thus, it may be appropriate to use separate or different techniques depending on the temperature of the liquid, or whether a heating operation is to be applied to the liquid, i.e. the eventual temperature of the liquid.

In some examples, generating the estimate of the volume of liquid output from the pump is further based on a technique selected from a plurality of techniques, the selection based on an indication of whether a duration of the operation period of the pump is greater than a predefined duration threshold. Rather than receive an indication of the pump power, or heating operation to be applied or temperature of the liquid as described above, the selection may be based on a duration of operation of the pump, i.e. the length of time the pump has been operating for that extraction or liquid output.

As can be seen from FIG. 6a, in some examples, the pump ramp-up reliably completes after a duration of 7 seconds of pump operation, such that after 7 s the pump can be expected to be operating at 100% power. Thus, a duration of time of pump operation can be used as a proxy to indicate that the pump is operating at full power. Different pumps, and indeed different heating approaches, may have different characteristics and thus different durations will indicate full pump power, and the predefined duration of operation, in this example 7 seconds, would vary accordingly in different implementations.

In some examples, the selection is based on a combination of the above selection criteria. In some examples, the selection is a two-stage selection, first based on whether a heating operation is to be applied, and second based on a time duration of pump operation. For example, it may first be determined whether a heating operation is to be applied to the liquid. This may be determined responsive to an indication of whether or not a heating operation is to be applied. If it is determined that a heating operation is not to be applied to the liquid, one of the techniques may be selected, which technique may be appropriate for and/or optimised for cold liquids. Alternatively, if it is determined that a heating operation is to be applied to the liquid, a different technique (appropriate for and/or optimised for hot liquids) may be applied. For example, one technique may be optimised for the first period of operation for hot beverages, and a second technique may be optimised for a second period after the first period of operation for hot beverages. In other words, once it has been determined that a heating operation is to be applied to the liquid, the selection is based on the duration of operation, i.e. time. In at least some implementations, a single technique may be suitable for cold beverages, given that thermoregulation and thus pump-ramp up are expected to be less relevant (or not at all relevant) for cold beverages.

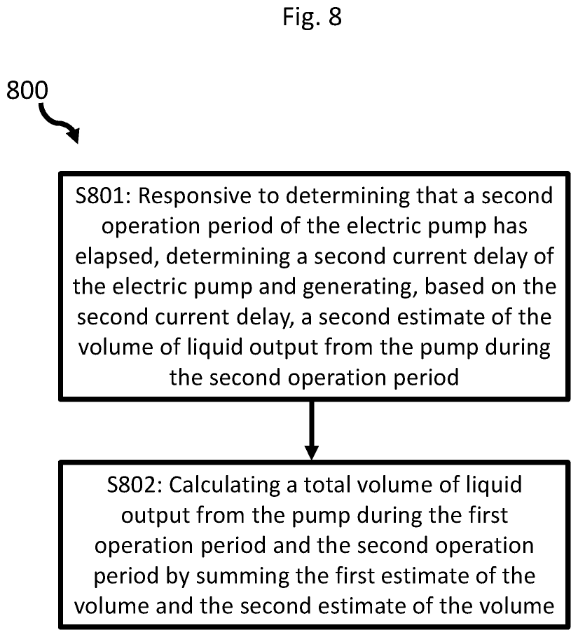

FIG. 8 schematically illustrates a method 800 for calculating a cumulative volume of liquid output from an electric pump according to techniques of the present disclosure. It will be appreciated that method 800 may operate sequentially after method 300. From one perspective, method 300 results in an estimation of volume output by the pump during a first operation period of the pump, for example 100 ms, and method 800 then defines the repeating of method 300 for a second operation period of the pump, and the summing of the estimates of volume from the first and second operation periods to calculate a total volume of liquid output by the pump during a total time period equal to the first and second operation periods.

More particularly, at step S801, responsive to determining that a second operation of the electric pump has elapsed, a second current delay of the electric pump is determined and a second estimate of the volume of liquid output from the pump during the second operation period is generated. The method 300 and associated examples may be repeated at step S801. Further, the elapsing of the second operation period may be determined based on a timer, for example a timer indicating that a predefined time period corresponding to an operation period has elapsed. In some examples, the length of operation period is 100 ms, the first and second operation periods being the same.

At step S802, a total volume of liquid output from the pump during the first operation period and the second operation period is calculated by summing the first estimate of the volume and the second estimate of the volume. In this way, a total volume of liquid output may be determined. This calculated total volume may then be used to control the pump, for example to deactivate the pump once a predetermined total volume has been reached. In examples where the described method is performed in the context of a beverage preparation apparatus, the beverage preparation apparatus may cease outputting liquid based on determining that the calculated total volume has reached the predetermined threshold. In this example, the predetermined threshold may be determined based on user input to the beverage preparation apparatus, for example through the selection of a beverage having a predefined volume.

In some examples, the generating of the second estimate of step S801 is based on a second technique, and the estimate from the first operation period is a first technique. This second technique may be selected from a plurality of techniques, for example the plurality of techniques used to select the technique for the estimate in the first operation period. Indeed, the second technique may be selected from the plurality of techniques based on at least one of: an indication of whether a power of the pump during the second operation period of the pump is above the predefined power threshold, an indication of whether a temperature of the liquid is greater than the predefined temperature threshold or whether a heating operation is to be applied to the liquid, and an indication of whether a duration of the first operation period and the second operation period of the pump is greater than the predefined duration threshold. It will be appreciated that the predefined power threshold, predefined temperature, and predefined duration threshold may be the same as for the first estimate and the second estimate, or they may differ.

Thus, as for the estimate of the volume from the first operation period, the second estimate may use a technique appropriate to and/or optimised for the conditions experienced during the second operation period. Thus, in at least some implementations, there may be achieved a more accurate estimate of the total volume output from the pump across the first and second operation periods.

In some examples, the first technique, i.e. the technique associated with generating the first estimate of the volume output during the first operation period, and the second technique are the same. For example, if the power of the pump has not crossed the predefined power threshold between the first and second operation periods, or that total duration of pump operation has not crossed the predefined duration threshold, the first and second techniques for the first and second operation periods may be the same. Further, as discussed above, based on an indication that a heating operation is not to be applied to the liquid, the technique may be the same across the first and second operation periods. In some examples, the second technique is automatically set to the first technique based on determining that a heating operation is not to be applied to the liquid. For cold liquids, for example, cold beverages, a pump power ramp-up is not required and so a single technique may be used for the duration of the extraction of the cold liquid.

Alternatively, the first technique and the second technique may be different. For example, the first and second operation periods may straddle a point at which the pump power crosses the predefined power threshold, or the duration of operation of the pump crosses the predefined duration threshold. The techniques of this disclosure thus allow for a fine-grain application of different techniques to best suit the conditions at the time, thus permitting the skilled reader to tailor any particular implementation to the specific circumstances of that implementation and thereby achieve high accuracy of the estimated volume output from the pump.

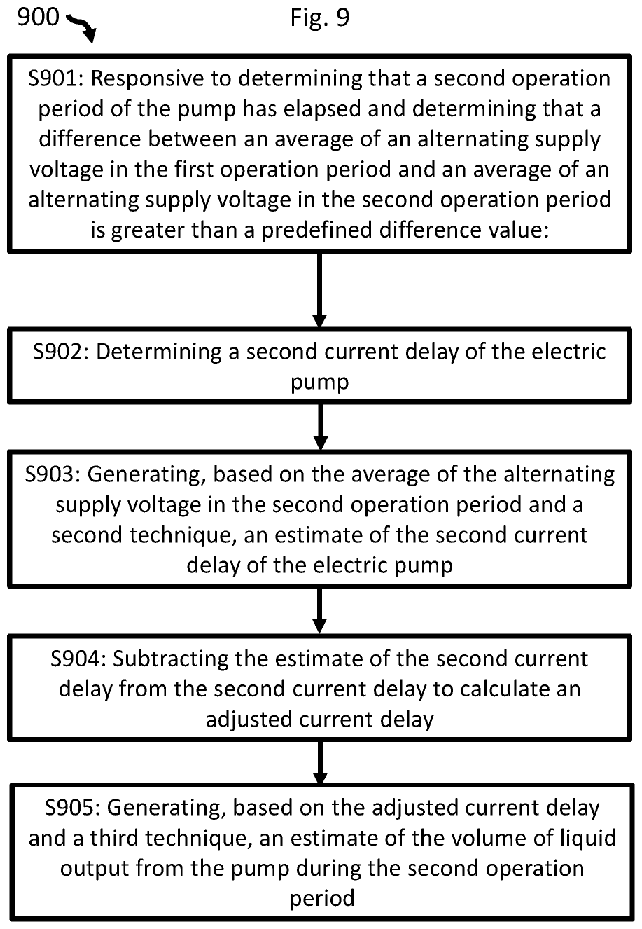

FIG. 9 schematically illustrates a method for estimating an estimate of the volume of liquid output during a second operation period after a first operation period. It will be appreciated that method 900 may sequentially follow method 300, or method 800. Indeed, these methods may be combined variously. Reference is made to a second operation period in a similar way as for method 800, but this does not require that these approaches are mutually exclusive alternatives, rather both approaches may be combined and either the two “second” periods may be the same period, or the two “second” periods may be distinct from one another such that one such “second” period maybe conceptually renamed as a “third” period.

The inventors of the present disclosure have identified that, in some cases, an alternating supply voltage may vary across operation periods of the pump. As shown in FIG. 5, the current delay and flow estimation may for some electric pumps be dependent on the supply voltage. Thus, for varying alternating supply voltages that vary considerably, a further series of techniques may be deployed to increase accuracy in the flow/volume estimation. From one perspective therefore, method 900 considers whether a supply voltage, for example the nominal supply voltage (e.g. 230V) or the supply voltage at the pump, is varying outside a predetermined threshold between subsequent time periods and processes accordingly if such a variation is occurring.

More particularly, in this example method 900, steps S902, S903, S904, and S905 may be performed following the determination at step S901, specifically these steps are performed responsive to determining that a second operation period of the pump has elapsed and determining that a difference between an average of an alternating supply voltage in the first operation period and an average of an alternating supply voltage in the second operation period is greater than a predefined difference value. As mentioned, the alternating supply voltage may be the alternating supply voltage supplied to the electric pump, in that it may be voltage supplied for utilisation by the pump or it may be the nominal supply voltage from the mains grid. This alternating supply voltage may be determined in a number of ways, for example from direct measurement, from measuring the supply voltage from the grid, or based on a phase cut of the voltage supplied from the grid. The predefined difference value may be determined based on a percentage of the alternating supply voltage in the first operation period.

At step S902, a second current delay of the electric pump is determined. This may be determined as described herein.

At step S903, based on the average of the alternating supply voltage in the second operation period and a second technique, an estimate of the second current delay of the electric pump is generated. In this example, the second technique is used to remove the effect of the varying voltage on the current delay and to generate an estimate of the current delay.

At step S904, the estimate of the second current delay is subtracted from the second current delay to calculate an adjusted current delay. In other words, a normalised current delay is calculated from subtracting the predicted current delay, predicted using the second technique, from the determined current delay.

At step S905, based on the adjusted current delay and a third technique, an estimate of the volume of liquid output from the pump during second operation period is generated. In this example, the third technique may be different from the second technique. The second technique in this example may be different from the second technique described in other examples herein.

Thus, in other words, method 900 provides an approach by which a more accurate estimate may be determined of the volume output from the pump when the supply voltage is varying considerably, i.e. when the supply voltage is treated as a continuous variable. In some situations, and in some locations, a largely non-varying supply voltage, for example grid voltage, cannot be assured and so the present technique can be used for relevant implementations so as to mitigate any negative impact of accuracy of flow estimation in such circumstances without needing a dedicated flowmeter in such situations and locations.

In some examples, the technique, the first technique, the second technique and/or the third technique described herein are a or a plurality of trained regression models trained based on performing regression analysis on training data comprising values of current delays of a test apparatus and volumes of liquid output by the test apparatus during operation of the test apparatus, where the test apparatus includes a pump corresponding in relevant manner to the electric pump. In some examples, the trained regression models may be trained linear regression models. Further, a technique corresponding to the first 7 seconds of extraction (or any predetermined time period), as discussed above, may be a model that produces a constant value. For example, in some cases, the first 7 seconds of extraction may be suitably estimated using a constant value, and then a second technique, for example a trained linear regression model, may then be used after the 7 second duration has elapsed. It will be appreciated that this duration, in this example 7 seconds, may vary depending on the specific implementation.

In other examples, a technique corresponding to the first 7 seconds of extraction (or any predetermined time period) may be a linear regression model. In this example, this first technique may be different from a linear regression model used after the first 7 seconds.

In some examples, a plurality of test apparatuses, such as test pumps or test beverage preparation apparatuses, may be operated with a flowmeter and operated to determine a current delay of the pump, to generate training data comprising measured values of flow, and current delays that may be used to generate an estimate of the flow.

An example trained linear regression model will now be described, that may correspond to any of the techniques discussed above. This trained linear regression model may comprise a number of determined constant model terms which, with a current delay and supply voltage, may be used to calculate a predicted volume of liquid output from the pump. Specifically, in this example, a predicted volume per unit time=parameter1+(parameter2×current delay)+(parameter3×supply voltage)+(parameter4×current delay×supply voltage). In this example, the parameter1, parameter2, parameter3, and parameter4 are constant terms identified using linear regression analysis. In this way, the current delay and supply voltage may be input to the trained linear regression model (i.e. input to an equation, like that above) and combined with the determined model parameters to produce an output corresponding to an estimation of the volume output during a time period. It will be appreciated that other equations may characterise the linear regression model. The linear regression models discussed herein refer to the one or more model parameters determined from linear regression analysis (i.e. training) and the equation that links the model parameters to the input and output variables (in this example, current delay, supply voltage, and volume estimate).

An example method for trained linear regression model selection will now be described, that may be utilised as part of any of the techniques described herein. In this example, it is first determined whether a heating operation is to be applied to the liquid. For example, this determination could be based on whether a user of a beverage preparation apparatus selects a hot beverage for preparation. If it is determined that no heating operation is to be applied, for example because a cold beverage was selected by a user, then a model may be used to predict a volume of liquid output from a pump as follows: predicted volume per unit time=parameter1+(parameter2×current delay)+(parameter3×supply voltage). In this example, the parameter1, parameter2, and parameter3 are constant terms identified using linear regression analysis. If it is determined that a heating operation is to be applied to the liquid, then a determination is made as to whether or not the pump is operating at or above a predetermined amount of the pump's nominal or maximum operating power, for example 100% of full power or 70% of full power. If the pump is determined to be operating at or above this predetermined amount, then a model may be used to predict a volume of liquid output from a pump as follows: predicted volume per unit time=parameter1+(parameter2×current delay)+(parameter3×supply voltage). In this example, the parameter1, parameter2, and parameter3 are constant terms identified using linear regression analysis and may be different from the constant terms associated with the situation when a heating operation is not to be applied to the liquid. If the pump is determined to be operating below this predetermined amount of power, then a model may be used to predict a volume of liquid output from a pump as follows: predicted volume per unit time=parameter1+(parameter2×pump power)+(parameter3×time elapsed since start of extraction)+(parameter4×temperature of the liquid). In this example, the parameter1, parameter2, parameter3, and parameter4 are constant terms identified using linear regression analysis and may be different from the constant terms associated with the situation when a heating operation is not to be applied to the liquid or when the pump is operating at or above a predetermined amount of power.

In the models discussed above, the current delay may be a normalised value. Such normalisation may be applied to account for physical variations between beverage preparation apparatuses of the same type. For example a number of beverage preparations of the same type may in fact exhibit a variation in behaviour between different ones of the apparatuses, for example due to variation in the performance of the pump, power delivery circuitry, heater etc. Thus, when manufacturing a given beverage preparation apparatus, a normalisation may be performed by performing a number of beverage preparation operations at the highest operational voltage of the apparatus, while not using any beverage preparation ingredient/capsule. In the case of a machine designed to work at mains voltage within most western Europe countries, this may for example be 265V. As the current delay is at its smallest when the voltage is at its highest, these beverage preparation operations will reveal the smallest possible current delay for the pump of the particular beverage preparation apparatus. The normalisation of the later values when applying the model to control the pump during operational use of the beverage preparation apparatus may then consist of subtracting that smallest possible current delay for the pump of the particular beverage preparation apparatus.

In the models discussed above, the supply voltage value may be a normalised value. Such normalisation may be applied to account for physical variations between beverage preparation apparatuses of the same type. For example a number of beverage preparations of the same type may in fact exhibit a variation in behaviour between different ones of the apparatuses, for example due to variation in the performance of the pump, power delivery circuitry, heater etc. Thus, when manufacturing a given beverage preparation apparatus, a normalisation may be performed by testing the voltage measured by the particular beverage preparation apparatus when supplied with a controlled voltage of two or more different voltage values. For example, the voltage measuring of the particular beverage preparation apparatus may be measured at each of 195V, 230V and 265V. The offset between the measured voltage and the known supply voltage at each supplied value is then determined and may be used to adjust a measured voltage during operational use of the beverage preparation apparatus. Such measurements may be carried out multiple times at each known supply voltage and an average offset determined. To account for the possibility of the offset being of different magnitude and/or different percentage of the actual supply voltage at the different measured points, an interpolation or fit may be applied to find a suitable offset value to apply at any given measured supply voltage during operation.

As discussed, each trained regression model may comprise one or more predetermined model parameters. Further, generating the estimate of the volume may comprise: inputting the current delay and an average of an alternating supply voltage supplied to the pump to the trained regression model; and performing one or more mathematical operations using the one or more predetermined model parameters, the current delay, and the average of the alternating supply voltage.

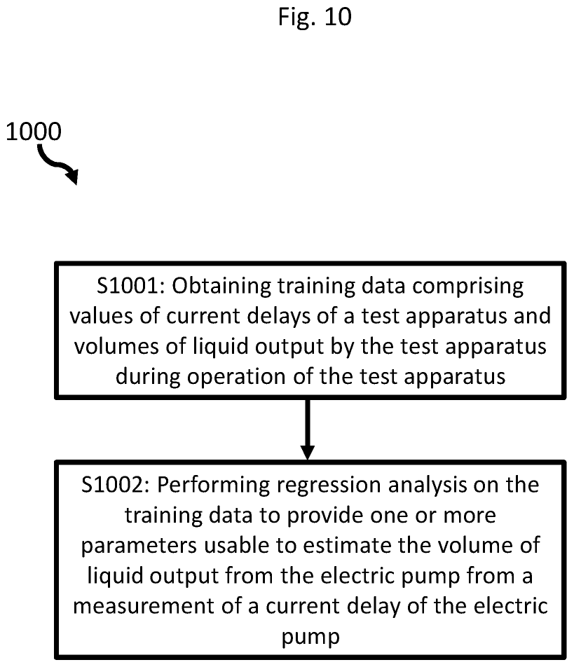

As shown in FIG. 10, at step S1001, training data comprising values of current delays of a test apparatus and volumes of liquid output by the test apparatus during operation of the test apparatus is obtained.

At step S1002, regression analysis on the training data is performed to provide one or more parameters usable to estimate the volume of liquid output from the electric pump from a measurement of a current delay of the electric pump.

In example method 1000, the test apparatus corresponds to the electric pump, and the current delays are periods between a first time corresponding to a first current drawn by the test apparatus, and a second time corresponding to a second current drawn by the test apparatus.

In some examples, the test apparatus comprises a plurality of test beverage preparation apparatuses. The training may comprise operating the machines to perform a predefined number of extractions following a test protocol that forces the pump to operate across a variety of different set-points (e.g. different performances). During this training, there may be a physical flow meter which measures the actual flow, and other variables including current delay are also logged. This data may be analysed and different types of regression models (with different combinations of parameters), in examples linear regression models, may be trained to fit the measured flow rate from the physical flow meter. For different regression models (i.e. models with different parameters), performance indicators are compared, for example the proportion of extractions that are out of a predefined tolerance compared to the physical flow meter, and the regression model is optimised and a suitably performant model (such as a most performant model as determined by relevant operational considerations for any given implementation) is selected for use.

In some examples, evaluating the performance of the chosen regression model may comprise implementing the selected regression model within firmware of a beverage preparation apparatus. This apparatus may be operated with the electric pump being controlled by the model rather than the physical flowmeter, and the physical flow meter may serve as the ground truth for evaluation of the model performance.

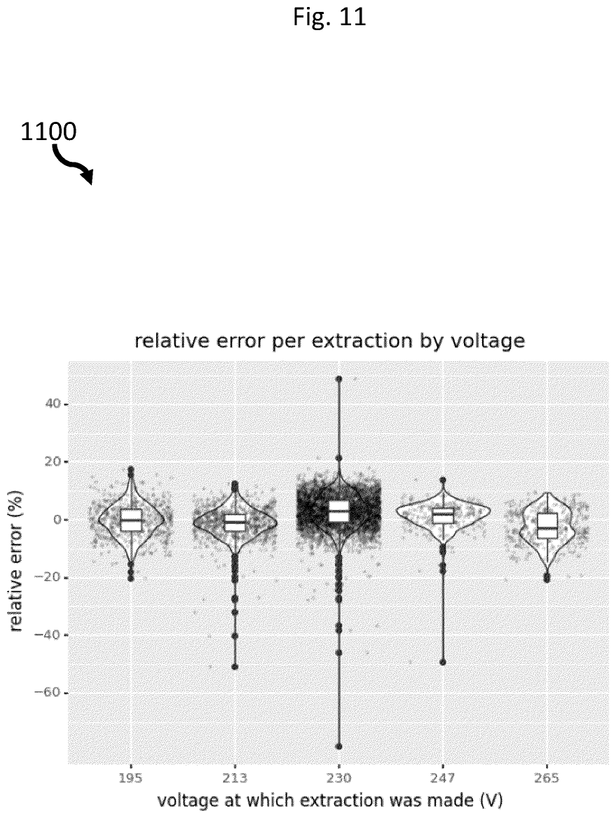

The present techniques are able to provide an accurate estimation of the volume of liquid output from an electric pump during an operation period of the electric pump. An example plot of the performance of the present techniques is shown in FIG. 11. Particularly, FIG. 11 shows the relative error per extraction, for different voltages, in this example at 195V, 213V, 230V, 247V, and 265V. The relative error is calculated based on comparing cumulative volume over time for a first apparatus using a dedicated flowmeter to measure the flow and calculate the cumulative volume, and for a second apparatus without the dedicated flowmeter and instead using the present techniques to estimate the flow and cumulative volume output over time. FIG. 11 shows the relative error in the volume prediction of liquid output from a pump using the techniques of the present disclosure compared to an apparatus using a dedicated flowmeter to measure the volume of liquid output from the pump over 5438 iterations, as an example. As shown in FIG. 11, of these iterations, 90% of volume predictions are within ±10% relative error, 96% are within ±12%, and 99% are within ±15% relative error.

It will be appreciated that a liquid dispensing machine comprising an electric pump and processing circuitry configured to perform the methods described herein may be provided rather than the beverage preparation apparatus 100 of FIG. 1.

Therefore, from one perspective, there has been described a method for estimating a volume of liquid output from an electric pump during an operation period of the electric pump, the method comprising: determining a current delay of the pump, wherein the current delay is a period between a first time corresponding to a first current drawn by the pump, and a second time corresponding to a second current drawn by the pump; and generating, based on the current delay, an estimate of the volume of liquid output from the electric pump during the operation period.

Further examples of the present approaches are set out in the following numbered clauses.

Clause 1. A method for estimating a volume of liquid output from an electric pump during an operation period of the electric pump, the method comprising: determining a current delay of the pump, wherein the current delay is a period between a first time corresponding to a first current drawn by the pump, and a second time corresponding to a second current drawn by the pump; and generating, based on the current delay, an estimate of the volume of liquid output from the electric pump during the operation period.

Clause 2. The method of clause 1, wherein the first current substantially corresponds to a zero-crossing of an alternating supply voltage supplied to the pump.

Clause 3. The method of any preceding clause, further comprising: determining an average of an alternating supply voltage supplied to the electric pump, wherein generating the estimate of the volume is further based on the average of the alternating supply voltage.

Clause 4. The method of any preceding clause, wherein determining the current delay of the pump comprises: determining the first time based on measurements of an alternating supply voltage supplied to the pump during the operation period; determining the second time based on measurements of a current drawn by the pump during the operation period; and calculating a difference between the first time and the second time as the current delay of the pump.

Clause 5. The method of any preceding clause, wherein the second time corresponds to a time proximal to the end of or within a time period over which a current drawn by the pump has substantially constant rate of change.

Clause 6. The method of any preceding clause, wherein generating the estimate of the volume of liquid output from the pump is further based on a technique selected from a plurality of techniques, the selection based on an indication of whether a power of the pump during the operation period of the pump is above a predefined power threshold.

Clause 7. The method of clauses 1 to 5, wherein generating the estimate of the volume of liquid output from the pump is further based on a technique selected from a plurality of techniques, the selection based on an indication of whether a temperature of the liquid is greater than a predefined temperature threshold or whether a heating operation is to be applied to the liquid.

Clause 8. The method of clauses 1 to 5, wherein generating the estimate of the volume of liquid output from the pump is further based on a technique selected from a plurality of techniques, the selection based on an indication of whether a duration of the operation period of the pump is greater than a predefined duration threshold.

Clause 9. The method of clauses 6 to 8, wherein the operation period of the pump is a first operation period, the current delay is a first current delay, and the estimate of volume is a first estimate of volume, the method further comprising: responsive to determining that a second operation period of the electric pump has elapsed, determining a second current delay of the electric pump and generating, based on the second current delay, a second estimate of the volume of liquid output from the pump during the second operation period; and calculating a total volume of liquid output from the pump during the first operation period and the second operation period by summing the first estimate of the volume and the second estimate of the volume.

Clause 10. The method of clause 9, wherein the technique is a first technique, and wherein the second estimate of the volume is generated based on a second technique selected from the plurality of techniques, the selection based on at least one of: an indication of whether a power of the pump during the second operation period of the pump is above the predefined power threshold, an indication of whether a temperature of the liquid is greater than the predefined temperature threshold or whether a heating operation is to be applied to the liquid, and an indication of whether a duration of the first operation period and the second operation period of the pump is greater than the predefined duration threshold.

Clause 11. The method of clause 10, wherein the first technique and second technique are the same.

Clause 12. The method of clause 10, wherein the first technique and second technique are different.

Clause 13. The method of clauses 6 to 8, wherein the operation period of the pump is a first operation period, the method further comprising: responsive to determining that a second operation period of the pump has elapsed and determining that a difference between an average of an alternating supply voltage in the first operation period and an average of an alternating supply voltage in the second operation period is greater than a predefined difference value: determining a second current delay of the electric pump; generating, based on the average of the alternating supply voltage in the second operation period and a second technique, an estimate of the second current delay of the electric pump; subtracting the estimate of the second current delay from the second current delay to calculate an adjusted current delay; and generating, based on the adjusted current delay and a third technique, an estimate of the volume of liquid output from the pump during the second operation period.

Clause 14. The method of clauses 6 to 13, wherein the technique, the first technique, the second technique and/or the third technique are a trained regression model trained based on performing regression analysis on training data comprising values of current delays of a test apparatus and volumes of liquid output by the test apparatus during operation of the test apparatus, wherein the test apparatus corresponds to the electric pump.

Clause 15. The method of clause 14, wherein the trained regression model comprises one or more predetermined model parameters, and wherein generating the estimate of the volume comprises: inputting the current delay and an average of an alternating supply voltage supplied to the pump to the trained regression model; and performing one or more mathematical operations using the one or more predetermined model parameters, the current delay, and the average of the alternating supply voltage.

Clause 16. A liquid dispensing machine comprising an electric pump and processing circuitry configured to perform the method of clauses 1 to 15.

Clause 17. The liquid dispensing machine of clause 16, wherein the liquid dispensing machine is configured to cease dispensing liquid in response to determining that the estimate of the volume of liquid output from the pump is equal to a predetermined threshold volume.

Clause 18. A computer-readable medium comprising instructions which, when executed by a programmable liquid dispensing machine, cause the programmable liquid dispensing machine to carry out the method of clauses 1 to 15.

Clause 19. A method for training a regression model to estimate a volume of liquid output from an electric pump during an operation period of the electric pump, the model comprising: obtaining training data comprising values of current delays of a test apparatus and volumes of liquid output by the test apparatus during operation of the test apparatus, wherein: the test apparatus corresponds to the electric pump; and the current delays are periods between a first time corresponding to a first current drawn by the test apparatus, and a second time corresponding to a second current drawn by the test apparatus; and performing regression analysis on the training data to provide one or more parameters usable to estimate the volume of liquid output from the electric pump from a measurement of a current delay of the electric pump.

Clause 20. A beverage preparation apparatus comprising: a fluid input connected to receive fluid for beverage preparation; an electric pump connected to the fluid input, and having a control input; a current sensor connected to an electrical power connection of the electric pump; a beverage preparation output connected to receive fluid dispensed by the electric pump; and a controller connected to the current sensor and to the control input, wherein the controller is configured to calculate a fluid volume dispensed by the electric pump based on a current draw delay measured by the current sensor, and to send a control signal to the control input to deactivate the electric pump responsive to the fluid volume reaching a threshold volume.

The methods discussed above may be performed under control of a computer program executing on a computing device, for example a programmable beverage preparation apparatus, or programmable liquid dispensing machine. Hence a computer program may comprise instructions for controlling a computing device to perform any of the methods discussed above. The program can be comprised in a computer-readable medium. A computer readable medium may include non-transitory type medium such as physical storage media, for example storage discs and solid state devices. A computer readable medium may additionally or alternatively include transient media such as carrier signals and transmission media, which may for example occur to convey instructions between a number of separate computer systems, and/or between components within a single computer system.

Therefore, the present teachings have provided an approach for estimating the flow of a liquid output by an electric pump so as to provide accurate estimation without the need for a flowmeter. These techniques, while being based around use of a current delay of the pump, can be adapted by using supplemental techniques and approaches to address complications such as liquid temperature, variable quality of supply voltage and the like. The estimates obtained by these approaches can be used to control when to switch off a pump that is being used to dispense a measured or predetermined quantity of liquid, which may find utility in devices such as beverage preparation machines where a defined quantity of liquid is specified for any given beverage to be prepared by the machine.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the disclosure scope defined by the claims or limitations on equivalents to the claims, and that other embodiments may be utilised and modifications may be made without departing from the scope and/or spirit of the claims.

1. A method for estimating a volume of liquid output from an electric pump during an operation period of the electric pump, the method comprising:
determining a current delay of the pump, wherein the current delay is a period between a first time corresponding to a first current drawn by the pump, and a second time corresponding to a second current drawn by the pump; and
generating, based on the current delay, an estimate of the volume of liquid output from the electric pump during the operation period.

2. The method of claim 1, wherein the first current substantially corresponds to a zero-crossing of an alternating supply voltage supplied to the pump.

3. The method of claim 1, further comprising:
determining an average of an alternating supply voltage supplied to the electric pump, wherein generating the estimate of the volume is further based on the average of the alternating supply voltage.

4. The method of claim 1, wherein determining the current delay of the pump comprises:
determining the first time based on measurements of an alternating supply voltage supplied to the pump during the operation period;
determining the second time based on measurements of a current drawn by the pump during the operation period; and
calculating a difference between the first time and the second time as the current delay of the pump.

5. The method of claim 1, wherein the second time corresponds to a time proximal to the end of or within a time period over which a current drawn by the pump has substantially constant rate of change.

6. The method of claim 1, wherein:
generating the estimate of the volume of liquid output from the pump is further based on a technique selected from a plurality of techniques, the selection based on an indication of whether a power of the pump during the operation period of the pump is above a predefined power threshold; and/or
generating the estimate of the volume of liquid output from the pump is further based on a technique selected from a plurality of techniques, the selection based on an indication of whether a temperature of the liquid is greater than a predefined temperature threshold or whether a heating operation is to be applied to the liquid; and/or
generating the estimate of the volume of liquid output from the pump is further based on a technique selected from a plurality of techniques, the selection based on an indication of whether a duration of the operation period of the pump is greater than a predefined duration threshold.

7. The method of claim 6, wherein the operation period of the pump is a first operation period, the current delay is a first current delay, and the estimate of volume is a first estimate of volume, the method further comprising:
responsive to determining that a second operation period of the electric pump has elapsed, determining a second current delay of the electric pump and generating, based on the second current delay, a second estimate of the volume of liquid output from the pump during the second operation period; and
calculating a total volume of liquid output from the pump during the first operation period and the second operation period by summing the first estimate of the volume and the second estimate of the volume.

8. The method of claim 7, wherein the technique is a first technique, and wherein the second estimate of the volume is generated based on a second technique selected from the plurality of techniques, the selection based on at least one of: an indication of whether a power of the pump during the second operation period of the pump is above the predefined power threshold, an indication of whether a temperature of the liquid is greater than the predefined temperature threshold or whether a heating operation is to be applied to the liquid, and an indication of whether a duration of the first operation period and the second operation period of the pump is greater than the predefined duration threshold, and optionally wherein the first technique and second technique are the same or different.

9. The method of claim 6, wherein the operation period of the pump is a first operation period, the method further comprising:
responsive to determining that a second operation period of the pump has elapsed and determining that a difference between an average of an alternating supply voltage in the first operation period and an average of an alternating supply voltage in the second operation period is greater than a predefined difference value:
determining a second current delay of the electric pump;
generating, based on the average of the alternating supply voltage in the second operation period and a second technique, an estimate of the second current delay of the electric pump;
subtracting the estimate of the second current delay from the second current delay to calculate an adjusted current delay; and
generating, based on the adjusted current delay and a third technique, an estimate of the volume of liquid output from the pump during the second operation period.

10. The method of claim 6, wherein the technique, the first technique, the second technique and/or the third technique are a trained regression model trained based on performing regression analysis on training data comprising values of current delays of a test apparatus and volumes of liquid output by the test apparatus during operation of the test apparatus, wherein the test apparatus corresponds to the electric pump.

11. The method of claim 10, wherein the trained regression model comprises one or more predetermined model parameters, and wherein generating the estimate of the volume comprises:
inputting the current delay and an average of an alternating supply voltage supplied to the pump to the trained regression model; and
performing one or more mathematical operations using the one or more predetermined model parameters, the current delay, and the average of the alternating supply voltage.

12. A liquid dispensing machine comprising an electric pump and processing circuitry configured to perform the method of claim 1.

13. The liquid dispensing machine of claim 12, wherein the liquid dispensing machine is configured to cease dispensing liquid in response to determining that the estimate of the volume of liquid output from the pump is equal to a predetermined threshold volume.

14. A computer-readable medium comprising instructions which, when executed by a programmable liquid dispensing machine, cause the programmable liquid dispensing machine to carry out the method of claim 1.

15. A method for training a regression model to estimate a volume of liquid output from an electric pump during an operation period of the electric pump, the model comprising:
obtaining training data comprising values of current delays of a test apparatus and volumes of liquid output by the test apparatus during operation of the test apparatus, wherein:
the test apparatus corresponds to the electric pump, and
the current delays are periods between a first time corresponding to a first current drawn by the test apparatus, and a second time corresponding to a second current drawn by the test apparatus; and
performing regression analysis on the training data to provide one or more parameters usable to estimate the volume of liquid output from the electric pump from a measurement of a current delay of the electric pump.

16. The method of claim 2, further comprising:
determining an average of an alternating supply voltage supplied to the electric pump, wherein generating the estimate of the volume is further based on the average of the alternating supply voltage.

17. The method of claim 3, wherein determining the current delay of the pump comprises:
determining the first time based on measurements of an alternating supply voltage supplied to the pump during the operation period;
determining the second time based on measurements of a current drawn by the pump during the operation period; and
calculating a difference between the first time and the second time as the current delay of the pump.

18. The method of claim 4, wherein the second time corresponds to a time proximal to the end of or within a time period over which a current drawn by the pump has substantially constant rate of change.

19. The method of claim 7, wherein the technique, the first technique, the second technique and/or the third technique are a trained regression model trained based on performing regression analysis on training data comprising values of current delays of a test apparatus and volumes of liquid output by the test apparatus during operation of the test apparatus, wherein the test apparatus corresponds to the electric pump.
